(19) United States
(12) Patent Application Publication
(10) Pub. No.: US 2022/0111861 A1
(43) Pub. Date: Apr. 14, 2022

(54) METHOD FOR PREVENTING FOGGING OF LENS, INTELLIGENT CONTROL DEVICE AND AUTONOMOUS DRIVING VEHICLE

(71) Applicant: Shenzhen Guo Dong Intelligent Drive Technologies Co., Ltd, Shenzhen (CN)

(72) Inventor: Jianxiong XIAO, Shenzhen (CN)

(73) Assignee: Shenzhen Guo Dong Intelligent Drive Technologies Co., Ltd, Shenzhen (CN)

(21) Appl. No.: 17/400,128

(22) Filed: Aug. 12, 2021

(30) Foreign Application Priority Data
Oct. 12, 2020 (CN) 202011087588.0

(51) Int. Cl. B60W 60/00; B60W 30/10; G01C 21/36

(52) U.S. Cl. CPC B60W 60/001; G01C 21/3617; B60W 30/10

(57) ABSTRACT

A method for preventing fogging is provided. The method for preventing fogging includes step of: acquiring a current position and a current time the autonomous driving vehicle; acquiring driving data of the autonomous driving vehicle and first environment data of the autonomous driving vehicle at the current position; determining an expected position and an expected time according to an expected path, the expected path being planned according to the current position and a destination position; acquiring the second environment data associated with the expected position and the expected time from an external database; obtaining environment difference data according to the first environment data and the second environment data; determining whether the environmental difference data meets predetermined fogging conditions according to a predetermined fogging standard; when the environmental difference data meets predetermined fogging conditions, activating a preventing fogging scheme based on the environmental difference data.

### CROSS REFERENCE TO RELATED APPLICATION

This non-provisional patent application claims priority under 35 U.S.C. § 119 from Chinese Patent Application No. 202011087588.0 filed on Oct. 12, 2020, the entire content of which is incorporated herein by reference.

### TECHNICAL FIELD

The disclosure relates to the field of autonomous driving technology, and in particular a method for preventing fogging of lens an intelligent control device and an autonomous driving vehicle.

### BACKGROUND

Camera device is an important sensor on the autonomous driving vehicle, which can capture the image data around the autonomous driving vehicle to identify the obstacles and other road signs around the autonomous driving vehicle. According to the obstacles and other road signs, the autonomous driving vehicle adjusts the trajectory and posture of the autonomous driving vehicle to ensure the safety of the autonomous driving vehicle.

However, during the autonomous vehicle driving, some specific environmental changes will cause the camera lens of the camera device to fog, which makes sight of the camera device is blocked and the camera device unable to capture the surrounding environment. There are some typical methods to solve the problem of lens fogging in the existing autonomous driving vehicles, typical methods to solve the problem is to remove the fog of the lens, that is, to take corresponding measures to eliminate the fog on the lens after the camera lens fogs, this will cause the camera device unable to capture images of the surrounding environment for a period of time before the fog on the lens is removed. When the autonomous driving vehicles is driving, and the road sections that lose the vision of camera device will lack a lot of real-time information, which makes the autonomous driving vehicles unable to sense the danger in time. It is very dangerous when the autonomous driving vehicles drives under such condition.

Therefore, there is a room for the autonomous driving vehicle.

### SUMMARY

The disclosure provides a method for preventing fogging of lens of an autonomous driving vehicle, an intelligent control device and an autonomous driving vehicle. The method for preventing fogging of lens of an autonomous driving vehicle improves the stability and safety of the autonomous driving vehicle in the process of driving.

A first aspect of the disclosure provides for preventing fogging of lens of an autonomous driving vehicle, the method for preventing fogging includes step of acquiring a current position and a current time the autonomous driving vehicle; acquiring driving data of the autonomous driving vehicle and first environment data of the autonomous driving vehicle at the current position by a plurality of sensors positioned on the autonomous driving vehicle; determining an expected position and an expected time that the autonomous driving vehicle will be reached during driving according to an expected path, the expected path being planned according to the current position and a destination position; acquiring the second environment data associated with the expected position and the expected time from an external database; obtaining environment difference data according to the first environment data and the second environment data; determining whether the environmental difference data meets predetermined fogging conditions according to a predetermined fogging standard; when the environmental difference data meets predetermined fogging conditions, activating an preventing fogging scheme based on the environmental difference data.

A second aspect of the disclosure provides an intelligent control device, the intelligent control device includes a memory and one or more processors. The memory is configured to store program instructions. The one or more processors are configured to execute the program instructions to perform a method for preventing fogging, the method for preventing fogging includes step of acquiring a current position and a current time the autonomous driving vehicle; acquiring driving data of the autonomous driving vehicle and first environment data of the autonomous driving vehicle at the current position by a plurality of sensors positioned on the autonomous driving vehicle; determining an expected position and an expected time that the autonomous driving vehicle will be reached during driving according to an expected path, the expected path being planned according to the current position and a destination position; acquiring the second environment data associated with the expected position and the expected time from an external database; obtaining environment difference data according to the first environment data and the second environment data; determining whether the environmental difference data meets predetermined fogging conditions according to a predetermined fogging standard; when the environmental difference data meets predetermined fogging conditions, activating an preventing fogging scheme based on the environmental difference data.

A third aspect of the disclosure provides an autonomous driving vehicle, the autonomous driving vehicle includes a main body, and intelligent control device. The intelligent control device includes a memory and one or more processors. The memory is configured to store program instructions. The one or more processors are configured to execute the program instructions to perform a method for preventing fogging, the method for preventing fogging includes step of acquiring a current position and a current time the autonomous driving vehicle; acquiring driving data of the autonomous driving vehicle and first environment data of the autonomous driving vehicle at the current position by a plurality of sensors positioned on the autonomous driving vehicle; determining an expected position and an expected time that the autonomous driving vehicle will be reached during driving according to an expected path, the expected path being planned according to the current position and a destination position; acquiring the second environment data associated with the expected position and the expected time from an external database; obtaining environment difference data according to the first environment data and the second environment data; determining whether the environmental difference data meets predetermined fogging conditions according to a predetermined fogging standard; when the environmental difference data meets predetermined fogging conditions, activating an preventing fogging scheme based on the environmental difference data.

The method of preventing the lens from fogging calculates the environment change data by using the current environment data obtained by the sensors on the autonomous driving vehicle and the future environment data obtained by the external database. When the environment changes will lead to the lens fogging, start the corresponding anti fogging scheme to prevent the lens fogging, so that the camera device can continuously and clearly perceive the surrounding environment, so as improve the stability and safety of the autonomous driving vehicle in the driving process.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates the methods for preventing fogging of lens of an autonomous driving vehicle in accordance with the first embodiment.

FIG. 2 illustrates the first sub-flow diagram of the methods for preventing fogging of lens of an autonomous driving vehicle in accordance with the first embodiment.

FIG. 3 illustrates the sub-flow diagram of the methods for preventing fogging of lens of an autonomous driving vehicle in accordance with the second embodiment.

FIG. 4 illustrates sub-flow diagram of the methods for preventing fogging of lens of an autonomous driving vehicle the in accordance with the first embodiment.

FIG. 5 illustrates sub-flow diagram of the methods for preventing fogging of lens of an autonomous driving vehicle in accordance with the first embodiment.

FIG. 6 illustrates a communication diagram of sensor unit in accordance the first embodiment.

FIG. 7a-7b illustrate a fog environment of lens in accordance the first embodiment.

FIG. 8 illustrates a sub-flow diagram the methods for preventing fogging of lens of an autonomous driving vehicle in accordance with the third embodiment.

FIG. 9 illustrates sub-flow diagram of the methods for preventing fogging of lens of an autonomous driving vehicle the in accordance with the first embodiment.

FIG. 10 illustrates a structure diagram of the intelligent control device in accordance with an embodiment.

FIG. 11 illustrates an autonomous driving vehicle in accordance with an embodiment.

### DETAILED DESCRIPTION OF THE EMBODIMENTS

In order to make the purpose, technical solution and advantages of the disclosure more clearly, the disclosure is further described in detail in combination with the drawings and embodiments. It is understood that the specific embodiments described herein are used only to explain the disclosure and are not used to define it. On the basis of the embodiments in the disclosure, all other embodiments obtained by ordinary technicians in this field without any creative effort are covered by the protection of the disclosure.

The terms “first”, “second”, “third”, “fourth”, if any, in the specification, claims and drawings of this application are used to distinguish similar objects and need not be used to describe any particular order or sequence of priorities. It should be understood that the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the disclosure are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

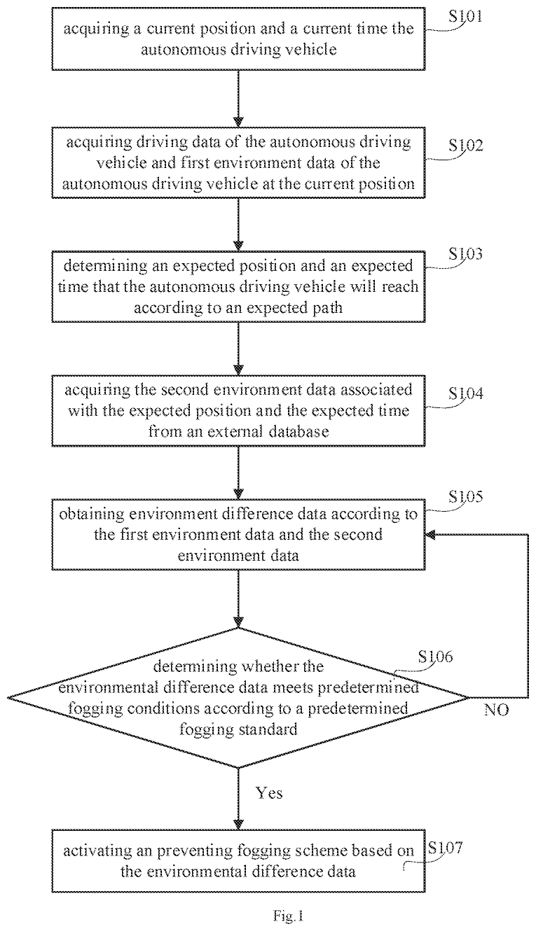

Referring to FIG. 1, FIG. 1 illustrates a method for preventing fogging of lens of an autonomous driving vehicle in accordance with a first embodiment. The methods for preventing fogging of lens of an autonomous driving vehicle includes following steps.

In step S101, a current position of the autonomous driving vehicle and current time of the autonomous driving vehicle is acquired. The current position and current time are acquired by GPS (Global Positioning System) or GNSS (Global Navigation Satellite System) installed in the autonomous driving vehicle.

In step S102, driving data of the autonomous driving vehicle and first environment data of the autonomous driving vehicle at the current position is acquired by several sensors installed on the autonomous driving vehicle. FIG. 6 illustrates a communication diagram of sensor in accordance the first embodiment. The sensors include a temperature sensor 606, a humidity sensor 607, a wheel speed sensor 603, a radar 602, a lidar 601 and a camera device 605. The first environment data is obtained by the temperature sensor 606 and the humidity sensor 603. The driving data is obtained by the wheel speed sensor 603, the radar 602, the lidar 601 and the camera 605. In this embodiment, the temperature sensor 606, the humidity sensor 607, the wheel speed sensor 603, the radar 602, the lidar 601 and the camera 605 send the sensed data to an electronic control unit (ECU) 610 of the autonomous driving vehicle. The ECU 610 is also referred to as “on-board computer”, “on-board computer” and the like. The ECU 610 may consist of a microprocessor (MCU), a memory (such as a ROM or a RAM), an input/output interface (I/O), an analog-to-digital converter (A/D), shaping circuit, driver and other large-scale integrated circuits. The ECU 610 is configured to process the sensing data and communicate with external database 609 and positioning unit 604 to obtain the data from external databases.

The temperature sensor 606 is configured to obtain a first temperature value of the current environment, the humidity sensor 607 is configured to obtain a first humidity value of the current environment, the wheel speed sensor 603 is configured to obtain a current driving speed of the autonomous driving vehicle, the radar 602 is configured to obtain point cloud data of the current environment, and the laser radar 601 is configured to obtain laser point cloud data of the current environment, and the imaging device 605 is configured to acquired image data of the current environment. The driving data includes the driving speed, the point cloud data, the laser point cloud data, and the image data. The first environmental data includes a first temperature value and a first humidity value. The first humidity value is relative humidity.

In step S103, an expected time and an expected position that the autonomous driving device will reach are determined according to an expected path. The expected path is planned according to the current position and the destination position. In some implement embodiments, the expected position can be determined first and then the expected time can be determined. In some implement embodiments, the expected time can be determined first, then the expected position is determined. How to determine the expected position and time according to the expected path will be described in detail below.

In step S104, second environment data associated with the expected position and the expected time are acquired from an external database. The external databases include V2X real-time databases and open databases provided by weather forecast websites. The V2X is a vehicle-road cooperative system. The vehicle-road cooperative system uses advanced wireless communication and new generation Internet technology to implement vehicle road dynamic real-time information interaction in an all-round way, and carries out vehicle active safety control and road collaborative management based on full time and space dynamic traffic information collection and fusion. It fully realizes the effective collaboration of people, vehicles and roads and ensures traffic safety, improves the traffic efficiency, as a result, it forms a safe, efficiently and environmentally friendly road traffic system. The second environmental data is obtained from the real-time database of V2X and the open database of weather forecast website. The second environmental data includes a second temperature value and a second humidity value. The second humidity value is relative humidity. Due to V2X real-time database and weather forecast website, the weather conditions of the expected position at the expected time can be quickly obtained, that the autonomous driving vehicle can prepare in advance for the weather that will be encountered, and improve the safety.

In step S105, environment difference data is calculated according to the first environment data and the second environment data. The environmental difference data is a value obtained by subtracting the second temperature value from the first temperature value.

In step S106, determining whether the environmental difference data meets the predetermined fogging conditions according to the predetermined fogging standard. The predetermined fogging standard is calculated according to the dew point temperature, in detail, the dew point temperature is a temperature at which the air cooling reaches saturation under the condition that the moisture content in the air remains unchanged and the air pressure remains constant.

In step S107, when the environmental difference data meets the predetermined fogging conditions, an anti fogging scheme corresponding to the environmental difference data is activated. The anti fogging schemes include a cooling scheme and a heating scheme. In detail, identifying whether the temperature difference is positive or negative, activating the cooling scheme when the temperature difference is positive number, and activating the heating scheme when the temperature difference is negative number.

As described above, the method preventing fogging can prevent the lens of the autonomous driving vehicle from being affected by the weather and environmental in time, and ensure that camera device can capture image all the time and sense the danger or other situations in time, as a result, it improves stability and safety of the autonomous driving vehicle during driving.

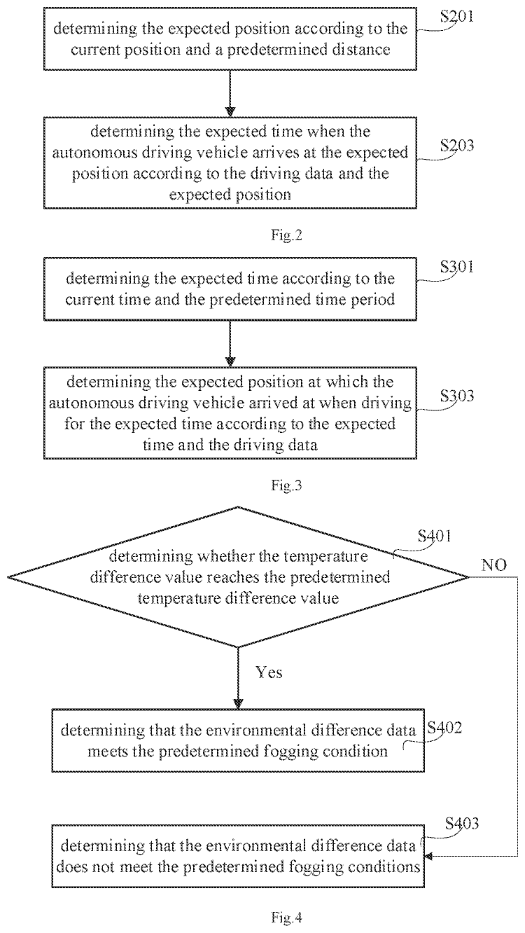

Referring to FIG. 2, a sub-flew diagram of the step S103 is illustrated in accordance with a first embodiment. In this embodiment, the expected position is determined first, and then the expected time is determined. In detail, the step S103 specifically includes the following steps.

In step S201, determining the expected position according to the current position and a predetermined distance. The predetermined distance has been set in the autonomous driving vehicle. For example, the predetermined distance is 16.7 km, the expected position is 16.7 km away from the current position in the driving direction.

In step S202, the expected time when the autonomous driving vehicle reaches the expected position is determined according to the driving data and the expected position. The driving data includes the current driving speed, the point cloud data, the laser point cloud data and the image data. A required time for which the autonomous driving device drives to arrive at the expected position is calculated according to the vehicle speed, the point cloud data, the laser point cloud data and image data, the expected time is the current time plus the required time. For example, if the current time is 20:00:00 and the driving speed of the autonomous driving vehicle is 50 km/h, and the driving speed can be calculated according to the road condition information, then the expected time is 20:20:00. When the road condition information is complex, for example, there are traffic lights in the 16.7 km distance to be driven, the autonomous driving vehicle calculates the expected time according to a predetermined time prediction algorithm.

Referring to FIG. 3, a sub-flew diagram of the step S103 is illustrated in accordance with a second embodiment. In step S103, the expected path is a driving path planned according to the current position and the destination position. In this embodiment, the expected time is determined first, and then the expected position is determined. In detail, the step S103 includes the following steps.

In step S301, the expected time is determined according to the current time and a predetermined time period. The predetermined time is preset in the autonomous driving vehicle. For example, the predetermined time period is 20 minutes, and the expected time is 20 minutes away from the current time.

In step S302, the expected position of the autonomous driving vehicle is determined according to the expected time and the driving data. The driving data includes the current driving speed, the point cloud data, laser point cloud data and image data. A distance that the autonomous driving vehicle can drive within the predetermined time period is calculated according to the road condition information analyzed based on vehicle speed, the point cloud data, laser point cloud data and image data. The expected position is away the distance that the autonomous driving vehicle can drive within the predetermined time period. For example, the current position is located at a coordinate point of (0,0,0), the driving direction of the autonomous vehicle is located at x-axis, a coordinate unit of the x-axis is km, the driving speed of the autonomous vehicle is 50 km/h, and when the autonomous driving device is analyzed to drive straight according to the road condition information, the expected position is (16.7,0,0). When the road condition information is complex, for example, when there are roadblocks or traffic lights on the road, the autonomous driving vehicle calculates a possible distance according to a predetermined distance algorithm. The predetermined distance algorithm can be obtained by testing many times.

In the above embodiment, the expected distance and expected time can be calculated according to the actual conditions, and it can real-time monitor the environment changes of the autonomous driving vehicle during and effectively predict the impact of the environment changes on the lens.

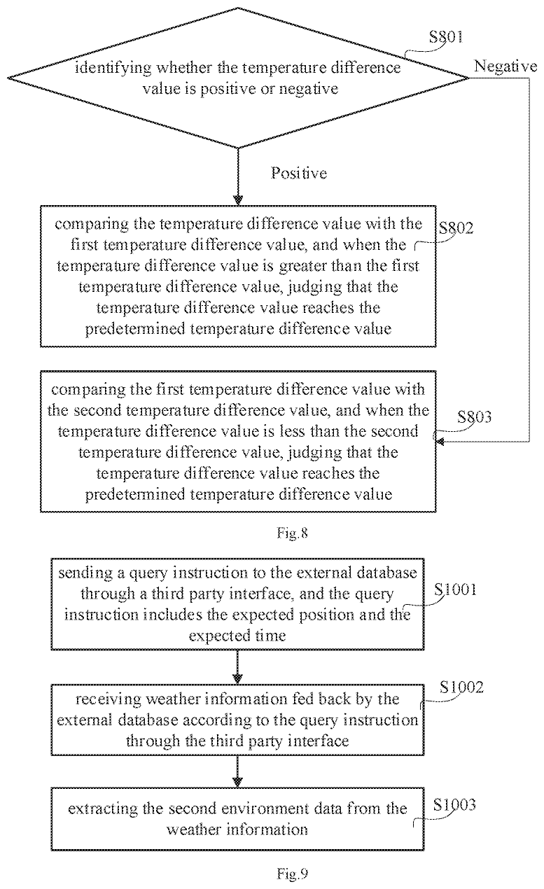

Referring to FIG. 9, a sub-flew diagram of the step S104 is illustrated in accordance with an embodiment with a first embodiment. In detail, the step S104 includes the following steps.

In step S1001, a query instruction is sent to the external database through a third-party interface, and the query instruction includes the expected position and the expected time. Specifically, the query instructions including the expected position and time are sent to the real-time database of the V2X and the open database of the weather forecast website via the third-party interface.

In step S1002, the weather information fed back by the external database according to the query instruction is received via the third-party interface. In other words, the weather information of the expected position at the expected time is received via the third-party interface. The weather information includes the second temperature value, the second humidity value and other data.

In step S1003, the second environment data is extracted from the weather information. In detail, the second environmental data includes a second temperature value and a second humidity value. The second temperature value and the second humidity value are extracted from the weather information.

Referring to FIG. 4, a sub-flew diagram of the step S106 is illustrated in accordance with a second embodiment with a first embodiment. In detail, the step S106 includes the following steps.

In step S401, it is determined that whether the temperature difference value reaches the predetermined temperature difference value.

In step S402, when the temperature difference value reaches the predetermined temperature difference value, the environmental difference data is determined to meet the predetermined fogging condition. In detail, when the first temperature value is 21° C., the second temperature value is 11° C. while the second humidity value is 65%, and the temperature difference value between the first temperature value and the second temperature value is 10 when the relative humidity is 65%. For example, the predetermined temperature difference value is 7 when the relative humidity is 65%. It is understood that, the temperature difference value is greater than the predetermined temperature difference value, that is, the temperature difference value reaches the predetermined temperature difference value. In this embodiment, the environmental difference data meets the predetermined fogging conditions.

In step S403, when the temperature difference value does not reach the predetermined temperature difference value, the environmental difference data is determined not to meet the predetermined fogging conditions. When the first temperature is 21° C., the second temperature is 18° C. and the second humidity is 45%, the predetermined temperature difference is 10 and the temperature difference is 3 when the relative humidity is 45%. When the temperature difference value is less than the predetermined temperature difference value, that is, when the temperature difference value does not reach the predetermined temperature difference value, it does not meet the predetermined fogging conditions.

In the above embodiment, the temperature difference can be used to judge whether the lens is fogging or not in advance, and the anti fogging scheme is activated to start to prevent the lens from fogging when the lens is judged to be fogging.

Referring to FIG. 8, a sub-flew diagram of the step S106 is illustrated in accordance with a second embodiment with a second embodiment. In detail, the step S106 includes the following steps.

In step S801, it is determined that whether the temperature difference value is positive or negative.

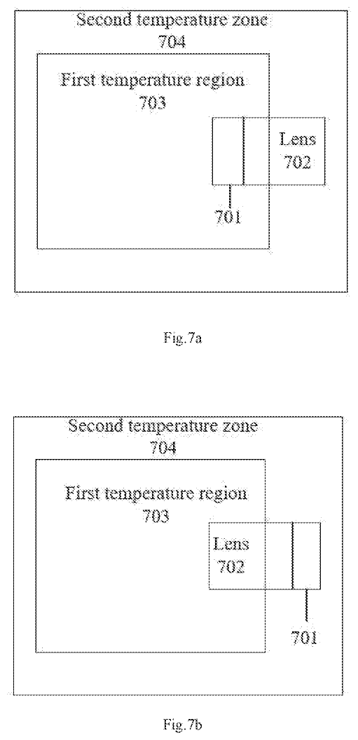

In step S802, when the temperature difference value is positive, the temperature difference value is compared with a first temperature difference value, and when the temperature difference value is greater than the first temperature difference value, it is determined that whether the temperature difference value reaches the predetermined temperature difference value. In detail, referring to FIG. 7a, the temperature of the first temperature region 703 is the first temperature value, and the temperature of the second temperature region 704 is the second temperature value. When the first temperature value is 21° C., the second temperature value is 11° C., and the second humidity value is 65%, the temperature of the first temperature region 703 is the first temperature value, and the temperature of the second temperature region 704 is the second temperature value. When the temperature difference value is 10, the inner side of the lens 702 fogs 701. At this time, it is compared with the first temperature difference 7 under this humidity. 10 is greater than 7, and in this embodiment, the environment difference data meets the predetermined fogging conditions.

In step S803, when the temperature difference value is negative, the temperature difference value is compared with a second temperature difference value, and when the temperature difference value is less than the second temperature difference value, the temperature difference value is determined to reach the predetermined temperature difference value. In detail, referring to FIG. 7b, the temperature of the first temperature region 703 is the first temperature value, and the temperature of the second temperature region 704 is the second temperature value. When the first temperature value is 5° C., the second temperature value is 11° C., and the second humidity value is 65%, the temperature of the first temperature region 703 is the first temperature value, and the temperature of the second temperature region 704 is the second temperature value. When the temperature difference value is −6, −6 is negative, and the outside of lens 702 fogs 701. At this time, it is compared with the second temperature difference of −5 under this humidity −6 is less than −5. In this embodiment, the environment difference data meets the predetermined fogging conditions.

The predetermined temperature difference is set according to the second humidity value. The larger the second humidity value is, the smaller the absolute value of the predetermined temperature difference is. The predetermined temperature difference is calculated according to the dew point temperature. Specifically, relative humidity is the ratio of the amount of water vapor contained in the air to the amount of water vapor saturated in the air at the current temperature, which is the saturation degree of air water vapor. The higher the degree of saturation, the easier the fog. For example, the relative humidity in the air is very high in winter, which makes it easier to fog. Therefore, the higher the second humidity value is, the smaller the absolute value of the predetermined temperature difference is.

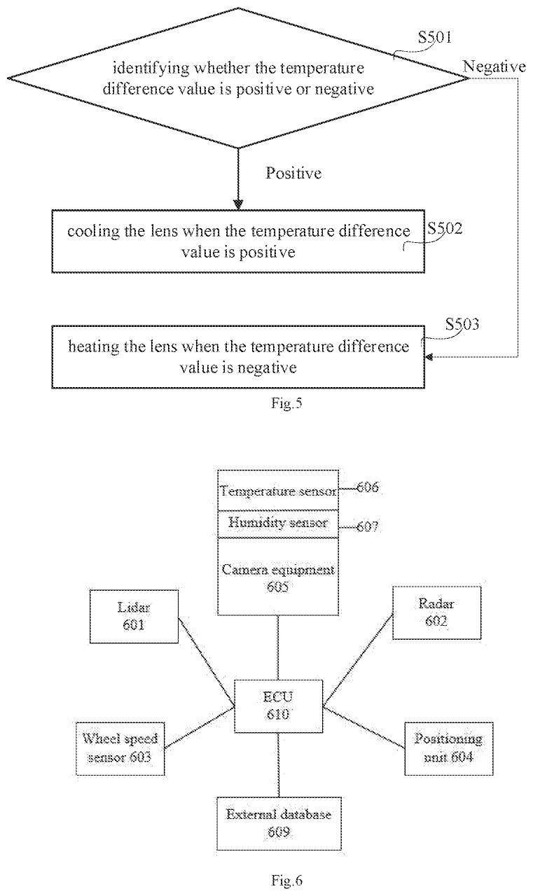

Referring to FIG. 5, a sub-flew diagram of the step S107 is illustrated in accordance with a second embodiment with a second embodiment. In detail, the step S107 includes the following steps.

In step S501, it is determined that whether the temperature difference value is positive or a negative

In step S502, cooling the lens, when the temperature difference value is positive. The lens is cooled by the cooling device installed on the autonomous driving vehicle. For example, the cooling device is fan. The fan is mounted on one side of the lens. The temperature around the lens reduces by blowing air, and the lens temperature is gradually close to the second temperature value, and the absolute value of the temperature difference value is reduced to prevent the lens from fogging.

In step S503, heating the lens, when the temperature difference value is negative. The lens is heated by the heating device installed on the autonomous driving vehicle. For example, the heating device is a heating coil, which is installed around the lens. the temperature around the lens increases by the heating coil, the lens temperature slowly close to the second temperature value, and the absolute value of the temperature difference value is reduced to prevent the lens from fogging.

In the above embodiment, the first humidity value or the second humidity value is configured to determine whether the temperature difference value meets the conditions, so that the autonomous driving vehicle can determine the current environmental factors accurately when there are different environmental changes, and an accurate adjustment scheme is planned.

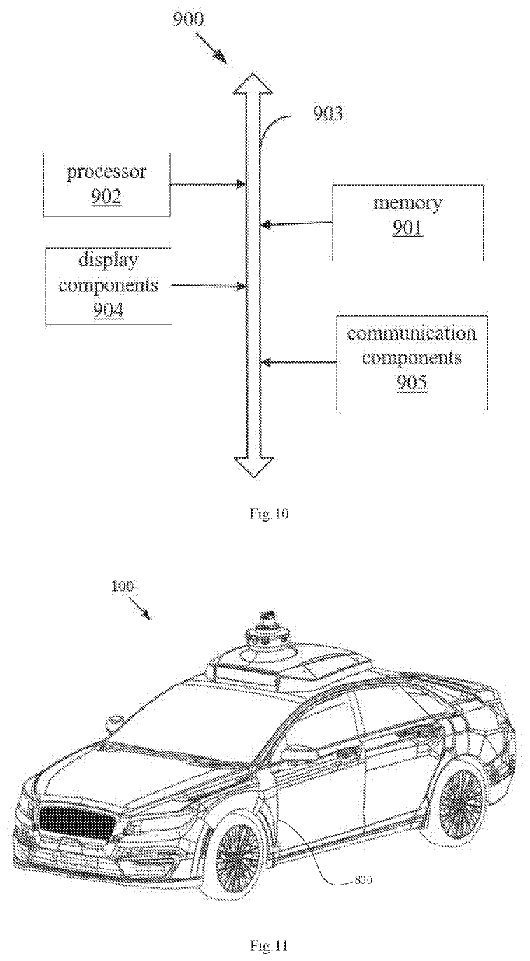

Referring to FIG. 10, a structure diagram of an intelligent control device is illustrated in accordance with the first embodiment.

In this embodiment, the intelligent control device 900 may be a tablet computer, a desktop computer, or a notebook computer. The intelligent control device 900 can be loaded with any intelligent operating system. The intelligent control device 900 includes a storage medium 901, a processor 902, and a bus 903. The storage medium 901 includes at least one type of readable storage medium, which includes flash memory, hard disk, multimedia card, card type memory (for example, SD or DX memory, etc.), magnetic memory, magnetic disk, optical disk, etc. In some embodiments, the storage medium 901 may be an internal storage unit of the intelligent control device 900, such as a hard disk of the intelligent control device 900. In some other embodiments, the storage medium 901 can also be an external storage device of the intelligent control device 900, such as a plug-in hard disk, a smart media card (SMC), a secure digital card (SD), a flash card, etc. equipped on the intelligent control device 900. Further, the storage medium 901 may include both an internal storage unit and an external storage device of the intelligent control device 900. The storage medium 901 can not only be used to store the application software and various kinds of data installed on the intelligent control device 900, but also be used to temporarily store the data that has been output or will be output.

The Bus 903 can be peripheral component interconnect (PCI) bus or extended industry standard architecture (EISA) bus. The bus can be divided into address bus, data bus and control bus. For the convenience of representation, only one thick line is used in FIG. 10, but it does not mean that there is only one bus or one type of bus. Further, the intelligent control device 900 may also include a display component 904. The display component 904 may be a light emitting diode (LED) display, a liquid crystal display, a touch type liquid crystal display, an organic light emitting diode (OLED) touch device, and the like. Among them, the display component 904 can also be appropriately called a display device or a display unit for displaying information processed in the intelligent control device 900 and a user interface for displaying visualization.

Furthermore, the intelligent control device 900 may also include a communication component 905, which may optionally include a wire communication component and/or a wireless communication component (such as a Wi-Fi communication component and/or a Bluetooth communication component), and is generally used to establish a communication connection between the intelligent control device 900 and other intelligent control devices. In some embodiments, the processor 902 may be a central processing unit (CPU), a controller, a micro-controller, a microprocessor or other data processing chip for running program code or processing data stored in the storage medium 901.

It can be understood that FIG. 10 only shows the intelligent control device 900 with components 901-905 and a method for realizing the prevention of lens fogging. It can be understood by those skilled in the art that the structure shown in FIG. 10 does not constitute a limitation on the intelligent control device 900, and may include fewer or more components than those shown in the figure, or a combination of some components, or different component arrangements.

In the above embodiment, the intelligent control device 900 includes a memory 901 for storing program instructions. The processor 902 is used for executing program instructions to enable the intelligent control device to realize any of the above methods for preventing the lens from fogging.

Referring to FIG. 11, an autonomous driving vehicle is illustrated in accordance with the first embodiment. The autonomous driving vehicle includes a main body 800 and the intelligent control device 900 as describe above installed on the main body 800 (shown in FIG. 11).

The unit described as a detached part may or may not be physically detached, the parts shown as unit may or may not be physically unit, that is, it may be located in one place, or it may be distributed across multiple network units. Some or all of the units can be selected according to actual demand to achieve the purpose of this embodiment scheme.

In addition, the functional units in each embodiment of this disclosure may be integrated in a single processing unit, or may exist separately, or two or more units may be integrated in a single unit. The integrated units mentioned above can be realized in the form of hardware or software functional units.

The integrated units, if implemented as software functional units and sold or used as independent product, can be stored in a computer readable storage medium. Based on this understanding, the technical solution of this disclosure in nature or the part contribute to existing technology or all or part of it can be manifested in the form of software product. The computer software product stored on a storage medium, including several instructions to make a computer equipment (may be a personal computer, server, or network device, etc.) to perform all or part of steps of each example embodiments of this disclosure. The storage medium mentioned before includes U disk, floating hard disk, ROM (Read-Only Memory), RAM (Random Access Memory), floppy disk or optical disc and other medium that can store program codes.

It should be noted that the embodiments number of this disclosure above is for description only and do not represent the advantages or disadvantages of embodiments. And in this disclosure, the term “including”, “include” or any other variants is intended to cover a non-exclusive contain. So that the process, the devices, the items, or the methods includes a series of elements not only include those elements, but also include other elements not clearly listed, or also include the inherent elements of this process, devices, items, or methods. In the absence of further limitations, the elements limited by the sentence “including a . . . ” do not preclude the existence of other similar elements in the process, devices, items, or methods that include the elements.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

1. A method for preventing fogging of lens of an autonomous driving vehicle, the autonomous driving vehicle equipped with sensors, wherein the method for preventing fogging comprises:
acquiring a current position and a current time the autonomous driving vehicle;
acquiring driving data of the autonomous driving vehicle and first environment data of the autonomous driving vehicle at the current position;
determining an expected position and an expected time that the autonomous driving vehicle will reach according to an expected path, the expected path being planned according to the current position and a destination position;
acquiring the second environment data associated with the expected position and the expected time from an external database;
obtaining environment difference data according to the first environment data and the second environment data;
determining whether the environmental difference data meets predetermined fogging conditions according to a predetermined fogging standard;
when the environmental difference data meets predetermined fogging conditions, activating a preventing fogging scheme based on the environmental difference data.

2. The method for preventing fogging as claimed in claim 1, wherein determining an expected position and an expected time that the autonomous driving vehicle will be reached during driving comprises:
determining the expected position according to the current position and a predetermined distance; and
determining the expected time when the autonomous driving vehicle arrives at the expected position according to the driving data and the expected position.

3. The method for preventing fogging as claimed in claim 1, wherein determining an expected position and an expected time that the autonomous driving vehicle will be reached during driving comprises:
determining the expected time according to the current time and the predetermined time period; and
determining the expected position at which the autonomous driving vehicle arrived at when driving for the expected time according to the expected time and the driving data.

4. The method for preventing fogging as claimed in claim 3, wherein the first environment data includes a first temperature value, the second environment data includes a second temperature value, the environment difference data includes a temperature difference value, the temperature difference value is obtained by subtracting the second temperature value from the first temperature value, and the predetermined fogging standard includes a predetermined temperature difference value, determining whether the environmental difference data meets predetermined fogging conditions according to a predetermined fogging standard comprises:
determining whether the temperature difference value reaches the predetermined temperature difference value;
when the temperature difference value reaches the predetermined temperature difference value, determining that the environmental difference data meets the predetermined fogging condition; or
when the temperature difference value does not reach the predetermined temperature difference value, determining that the environmental difference data does not meet the predetermined fogging conditions.

5. The method for preventing fogging as claimed in claim 4, wherein when the environmental difference data meets predetermined fogging conditions, activating a preventing fogging scheme based on the environmental difference data comprises:
identifying whether the temperature difference value is positive or negative;
cooling the lens when the temperature difference value is positive;
heating the lens when the temperature difference value is negative.

6. The method for preventing fogging as claimed in claim 5, wherein the lens is cooled by the cooling device installed on the autonomous driving vehicle.

7. The method for preventing fogging as claimed in claim 5, wherein the lens is heated by the heating device installed on the autonomous driving vehicle.

8. The method for preventing fogging as claimed in claim 4, wherein the predetermined temperature difference includes a first temperature difference and a second temperature difference to judge whether the temperature difference reaches the predetermined temperature difference, further comprises:
identifying whether the temperature difference value is positive or negative;
when the temperature difference value is positive, comparing the temperature difference value with the first temperature difference value, and
when the temperature difference value is greater than the first temperature difference value, judging that the temperature difference value reaches the predetermined temperature difference value; or
when the temperature difference value is negative, comparing the first temperature difference value with the second temperature difference value, and
when the temperature difference value is less than the second temperature difference value, judging that the temperature difference value reaches the predetermined temperature difference value.

9. The method for preventing fogging as claimed in claim 8, wherein the second environment data includes a humidity value, and the method for preventing the lens from fogging, further comprises:
setting the predetermined temperature difference according to the humidity value, wherein the second humidity value is the larger the absolute value of the predetermined temperature difference is the smaller.

10. The method for preventing fogging as claimed in claim 1, wherein acquiring the second environment data associated with the expected position and the expected time from an external database comprises:
sending a query instruction to the external database through a third party interface, and the query instruction includes the expected position and the expected time;
receiving weather information fed back by the external database according to the query instruction through the third party interface;
extracting the second environment data from the weather information.

11. The method for preventing fogging as claimed in claim 1, wherein sensors for acquiring the first environment data and the second environment data include a temperature sensor, a humidity sensor, a wheel speed sensor, a radar, a lidar and an imaging device, the temperature sensor and the humidity sensor are configured to obtain the first environmental data; the wheel speed sensor, the radar, the lidar, and the imaging device are configured to obtain the driving data.

12. An intelligent control device, the intelligent control device comprising:
a memory configured to store program instructions; and
one or more processors configured to execute the program instructions to perform a method for preventing fogging, the method for preventing fogging comprising:
acquiring a current position and a current time the autonomous driving vehicle;
acquiring driving data of the autonomous driving vehicle and first environment data of the autonomous driving vehicle at the current position by a plurality of sensors positioned on the autonomous driving vehicle;
determining an expected position and an expected time that the autonomous driving vehicle will be reached during driving according to an expected path, the expected path being planned according to the current position and a destination position;
acquiring the second environment data associated with the expected position and the expected time from an external database;
obtaining environment difference data according to the first environment data and the second environment data;
determining whether the environmental difference data meets predetermined fogging conditions according to a predetermined fogging standard;
when the environmental difference data meets predetermined fogging conditions, activating a preventing fogging scheme based on the environmental difference data.

13. The intelligent control device as claimed in claim 12, wherein determining an expected position and an expected time that the autonomous driving vehicle will be reached during driving comprises:
determining the expected position according to the current position and a predetermined distance; and
determining the expected time when the autonomous driving vehicle arrives at the expected position according to the driving data and the expected position.

14. The intelligent control device as claimed in claim 12, wherein determining an expected position and an expected time that the autonomous driving vehicle will be reached during driving comprises:
determining the expected time according to the current time and the predetermined time period; and
determining the expected position at which the autonomous driving vehicle arrived at when driving for the expected time according to the expected time and the driving data.

15. The intelligent control device as claimed in claim 14, wherein the first environment data includes a first temperature value, the second environment data includes a second temperature value, the environment difference data includes a temperature difference value, the temperature difference value is obtained by subtracting the second temperature value from the first temperature value, and the predetermined fogging standard includes a predetermined temperature difference value, determining whether the environmental difference data meets predetermined fogging conditions according to a predetermined fogging standard comprises:
determining whether the temperature difference value reaches the predetermined temperature difference value;
when the temperature difference value reaches the predetermined temperature difference value, determining that the environmental difference data meets the predetermined fogging condition; or
when the temperature difference value does not reach the predetermined temperature difference value, determining that the environmental difference data does not meet the predetermined fogging conditions.

16. The intelligent control device claimed in claim 15, wherein when the environmental difference data meets predetermined fogging conditions, activating an preventing fogging scheme based on the environmental difference data comprises:
identifying whether the temperature difference value is positive or negative;
cooling the lens when the temperature difference value is positive;
heating the lens when the temperature difference value is negative.

17. The intelligent control device as claimed in claim 16, wherein the lens is cooled by the cooling device installed on the autonomous driving vehicle.

18. The intelligent control device as claimed in claim 16, wherein the lens is heated by the heating device installed on the autonomous driving vehicle.

19. The intelligent control device in claim 15, wherein the predetermined temperature difference includes a first temperature difference and a second temperature difference to judge whether the temperature difference reaches the predetermined temperature difference, further comprises:
identifying whether the temperature difference value is positive or negative;
when the temperature difference value is positive, comparing the temperature difference value with the first temperature difference value, and
when the temperature difference value is greater than the first temperature difference value, judging that the temperature difference value reaches the predetermined temperature difference value; or
when the temperature difference value is negative, comparing the first temperature difference value with the second temperature difference value, and
when the temperature difference value is less than the second temperature difference value, judging that the temperature difference value reaches the predetermined temperature difference value.

20. An autonomous driving vehicle, the autonomous driving vehicle comprising:
a main body;
an intelligent control device, the intelligent control device comprising:
a memory configured to store program instructions; and
one or more processors configured to execute the program instructions to perform a method for preventing fogging, the method for preventing fogging comprising:
acquiring a current position and a current time the autonomous driving vehicle;
acquiring driving data of the autonomous driving vehicle and first environment data of the autonomous driving vehicle at the current position by a plurality of sensors positioned on the autonomous driving vehicle;
determining an expected position and an expected time that the autonomous driving vehicle will be reached during driving according to an expected path, the expected path being planned according to the current position and a destination position;
acquiring the second environment data associated with the expected position and the expected time from an external database;
obtaining environment difference data according to the first environment data and the second environment data;
determining whether the environmental difference data meets predetermined fogging conditions according to a predetermined fogging standard;
when the environmental difference data meets predetermined fogging conditions, activating a preventing fogging scheme based on the environmental difference data.
